(19) United States
(12) Patent Application Publication
(10) Pub. No.: US 2011/0157417 A1
(43) Pub. Date: Jun. 30, 2011

(54) ELECTRONIC DEVICE AND LIGHT CONTROL METHOD THEREOF

(75) Inventors: CHI-CHIH WANG, Tu-Cheng (TW); QUAN-ZHONG ZHANG, Shenzhen City (CN); FEI HUO, Shenzhen City (CN); LI ZHANG, Shenzhen City (CN)

(73) Assignees: GDS SOFTWARE (SHENZHEN) CO.,LTD, ShenZhen City (CN); HON HAI PRECISION INDUSTRY CO., LTD., Tu-Cheng (TW)

(21) Appl. No.: 12/868,744

(22) Filed: Aug. 26, 2010

(30) Foreign Application Priority Data
Dec. 30, 2009 (CN) 200910312794.4

(51) Int. Cl. H04N 5/235

(52) U.S. Cl. 348/229.1; 348/E05.034

(57) ABSTRACT

An electronic device automatically adjusts luminance of a monitor device, such as an image capture device. The electronic device analyzes captured images and determines brightness thereof. If the luminance of the captured images are too dark, the electronic device widens an aperture of the monitor device or turns up a supplementary lighting device. If the luminance is too high, the electronic device narrows the aperture of the monitor device or decreases output of the supplementary lighting device.

### BACKGROUND

1. Technical Field

Embodiments of the present disclosure relate to video capture, and more particularly to an electronic device and light control method thereof.

2. Description of Related Art

Maintaining contrast and clarity is critical during video capture, particularly for automatic surveillance systems. Currently, many electronic devices used in such applications, such as, for example, surveillance systems, provide basic light control functions. However, these functions are often rudimentary, often involving light sensors to feed back existing environmental luminance. The cost of hardware required to implement sensor-based light control function in such devices, however, is high.

### BRIEF DESCRIPTION OF THE DRAWINGS

FIG. 1 is a block diagram of one embodiment of an electronic device utilizing a light control system.

FIG. 2 is a flowchart illustrating one embodiment of a method for light control of an electronic device.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the module may be integrated in firmware, such as an EPROM. It will be appreciated that module may comprise connected logic units, such as gates and flip-flops, and may comprise programmable units, such as programmable gate arrays or processors. The units described herein may be implemented as software and/or hardware unit and may be stored in any type of computer-readable medium or other computer storage device.

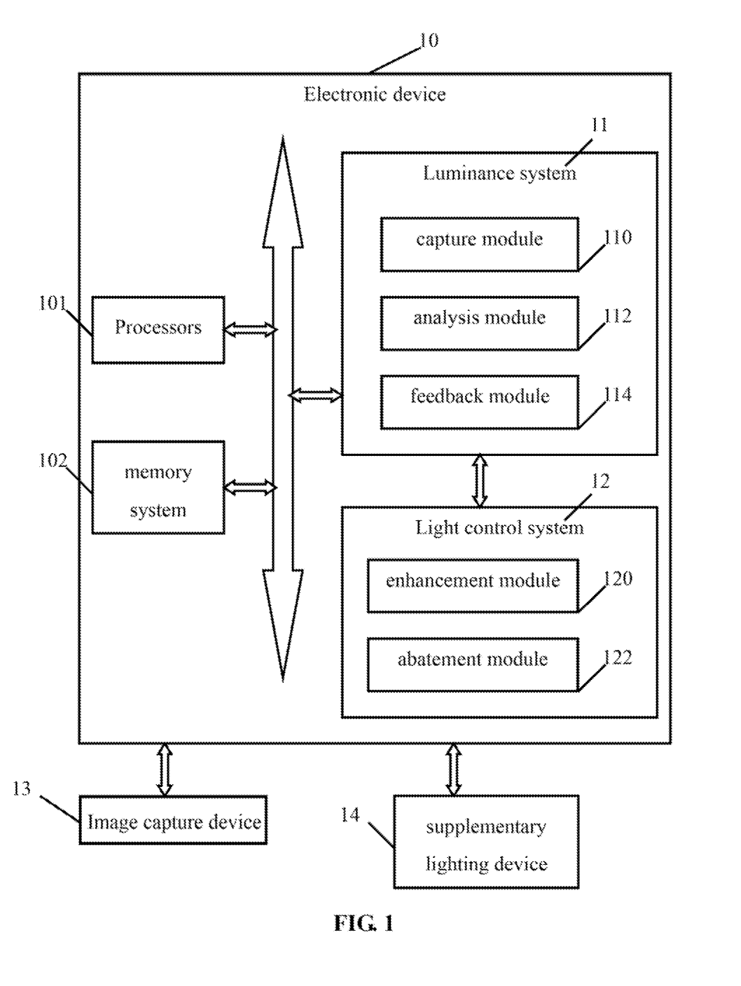

FIG. 1 is a block diagram of an electronic device 10 comprising a luminance system 11 and a light control system 12. The luminance system 11 samples images captured by an image capture device 13. The image capture device 13 is electronically connected with the electronic device 10. In the embodiment, the image capture device 13 can be a camera or a video recorder. The luminance system 11 measures luminance of the sampled images, and provides the result to the light control system 12. The light control system 12 adjusts an aperture of the image capture device 13, and a supplementary lighting device 14 accordingly. Depending on the embodiment, the electronic device 10 can be a personal computer or notebook, for example. The supplementary lighting device 14 can be an LED light, fluorescent, or other light types.

In the embodiment, the luminance system 11 comprises programs including a capture module 110, an analysis module 112, and a feedback module 114. The light control system 12 comprises a light enhancement module 120 and a light abatement module 122. One or more computerized codes of the modules 110-122 are stored in a memory system 102 and executed by one or more processors 101 of the electronic device 10.

In the embodiment, the capture module 110 samples an image captured by the image capture device 13, periodically or on demand The analysis module 112, computes an average luminance for the sampled image, and compares the average luminance with a predetermined threshold.

In the embodiment, if the average luminance exceeds the predetermined threshold by a predetermined margin, the feedback module 114 sends an electronic signal to the light control system 12 so as to increase the luminance (hereinafter “the enhancement signal”). When the light control system 12 receives the enhancement signal, the light enhancement module 120 widens the aperture of the image capture device 13 to admit more light, and increases the output of the supplementary lighting device 14 if the aperture has reached a maximum value, until the average luminance is within the predetermined margin.

In the embodiment, if the average luminance is below the predetermined threshold by a predetermined margin, the feedback module 114 sends an electronic signal to the light control system 12 so as to decrease the luminance (hereinafter “the abatement signal”). When the light control system 12 receives the abatement signal, the light abatement module 122 decreases output of the supplementary lighting device 14, and narrows the aperture of the image capture device 13 if the supplementary lighting device 14 is off, until the average luminance is within the predetermined margin.

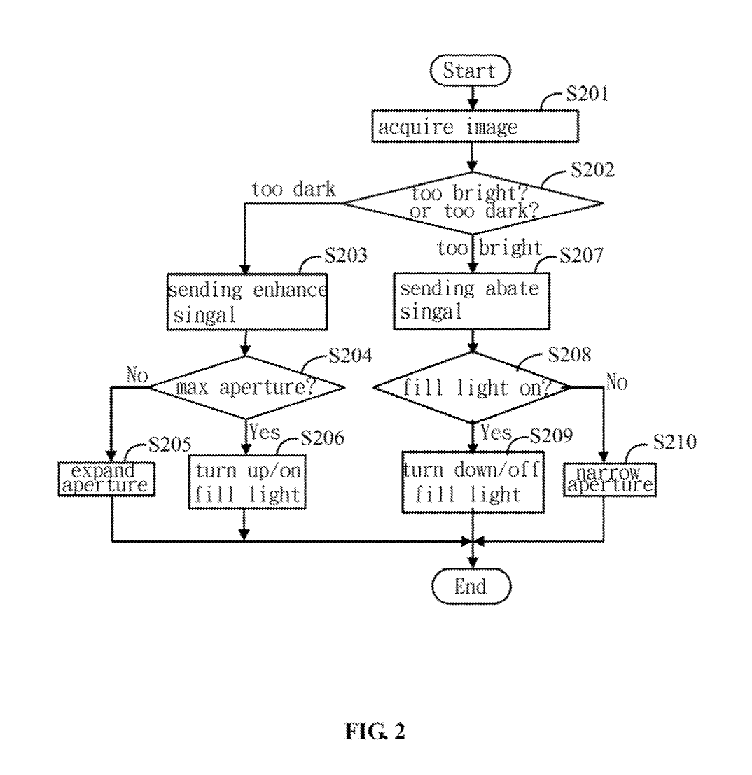

FIG. 2 is a flowchart illustrating one embodiment of a method for light control of the electronic device 10. Additional blocks may be added to the method, others removed, and the ordering of the blocks may be changed.

In block S201, the capture module 110 samples an image captured by the image capture device 13, periodically or on demand In block S202, the analysis module 112 assesses brightness of the sampled image. If the sampled image is too dark, block S203 is implemented. If the sampled image is too bright, block S207 is implemented. In block S203, the feedback module 114 sends the enhancement signal to the light control system 12. In block S204, the light enhancement module 120 determines whether the aperture of the image capture device 13 has reached a maximum value. If the aperture of the image capture device 13 has reached a maximum value, block S206 is implemented. Otherwise, block S205 is implemented, in which light enhancement module 120 widens the aperture of the image capture device 13 until the average luminance of the sampled image is within the predetermined margin or the aperture of the image capture device 13 has reached a maximum. In block S206, the light enhancement module 120 increases output of the supplementary lighting device 14 until the average luminance of the sampled image is within the predetermined margin.

In block S207, the feedback module 114 sends the abatement signal to the light control system 12. In block S208, the light abatement module 122 determines whether the supplementary lighting device 14 is on. If the supplementary lighting device 14 is on, block S209 is implemented. Otherwise, if the supplementary lighting device 14 is off, block S210 is implemented. In block S209, the light abatement module 122 decreases output of the supplementary lighting device 14 until the average luminance is within the predetermined margin or the supplementary lighting device 14 is off. In block S210, the light abatement module 122 narrows the aperture of the image capture device 13 if the supplementary lighting device 14 is off until the average luminance is within the predetermined margin.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device electronically connected with an image capture device and a supplementary lighting device, the electronic device comprising:
a memory system;
one or more processors; and
one or more programs stored in the memory system configured to be executed by the one or more processors, the one or more programs comprising:
a capture module to acquire an image from the image capture device; and
an analysis module to determine brightness of the acquired image;
wherein the electronic device sends an electronic signal to a light control system, according to the brightness of the acquired image;
wherein the light control system controls an aperture of the image capture device, and supplementary lighting device, according to the received electronic signal.

2. The device as claimed in claim 1, wherein the analysis module computes an average luminance of the acquired image and compares the result with a predetermined threshold.

3. The device as claimed in claim 1, wherein the light control system comprises a light enhancement module to widen the aperture of image capture device and a light abatement module to narrow the aperture of image capture device, according to the received electronic signal.

4. The device as claimed in claim 3, wherein the light enhancement module widens an aperture of the image capture device and implements the supplementary lighting device if the aperture has reached a maximum value, until the average luminance of the acquired image is within a predetermined margin.

5. The device as claimed in claim 3, wherein the light abatement module decreases output of the supplementary lighting device and narrows the aperture of the image capture device if the supplementary lighting device is off, until the average luminance of the acquired image is within a predetermined margin.

6. A computerized method of an electronic device electronically connected with an image capture device and a supplementary lighting device, comprising:
acquiring an image from the image capture device;
analyzing luminance of the acquired image; and
sending an electronic signal to a light control system according to the luminance of the acquired image;
wherein the light control system controls an aperture of the image capture device, and supplementary lighting device, according to the received electronic signal.

7. The computerized method as claimed in claim 6, wherein analysis of the captured image further comprises computing an average luminance of the acquired image and comparison thereof with a predetermined threshold.

8. The computerized method as claimed in claim 6, wherein control of the supplementary lighting device comprises increasing and decreasing luminance.

9. The computerized method as claimed in claim 8, wherein increasing luminance comprises widening an aperture of the image capture device and implementing the supplementary lighting device if the aperture has reached a maximum, until the average luminance of the acquired image is within a predetermined margin.

10. The computerized method as claimed in claim 8, wherein reduction of luminance comprises lowering output of the supplementary lighting device, and narrowing the aperture of the image capture device if the supplementary lighting device is off, until the average luminance of the acquired image is within a predetermined margin.

11. A computer readable storage medium having stored therein instructions, that when executed by one or more processors of an electronic device electronically connected with an image capture device and a supplementary lighting device, cause the device to:
acquire an image from the image capture device;
analyze the acquired image and determine brightness thereof; and
send an electronic signal to a light control system according to the brightness of the acquired image;
wherein the light control system controls an aperture of the image capture device and supplementary lighting device according to the received adjustment signal.

12. The computer readable storage medium as claimed in the claim 11, wherein analysis of the captured image further comprises computing an average luminance of the acquired image and comparison thereof with a predetermined threshold.

13. The computer readable storage medium as claimed in the claim 11, wherein control of the supplementary lighting device further comprises increasing and decreasing luminance.

14. The computer readable storage medium as claimed in the claim 13, wherein increasing luminance comprises, widening an aperture of the image capture device and implementing the supplementary lighting device if the aperture has reached a maximum, until the average luminance of the acquired image is within a predetermined margin.

15. The computer readable storage medium as claimed in the claim 13, wherein reduction of luminance comprises lowering output of the supplementary lighting device and narrowing the aperture of the image capture device if the supplementary lighting device is off, until the average luminance of the acquired image is within a predetermined margin.
